(19) United States
(12) Patent Application Publication
(10) Pub. No.: US 2020/0375709 A1
(43) Pub. Date: Dec. 3, 2020

(54) Hemp Filament Floss

(71) Applicant: Whitney Rene Retta, Studio City, CA (US)

(72) Inventor: Whitney Rene Retta, Studio City, CA (US)

(21) Appl. No.: 16/869,558

(22) Filed: May 7, 2020

Related U.S. Application Data
(60) Provisional application No. 62/856,039, filed on Jun. 1, 2019.

(51) Int. Cl. A61C 15/04

(52) U.S. Cl. CPC A61C 15/042; A61C 2201/00

(57) ABSTRACT

The preset invention is comprised of a novel hemp filament floss generally consisting of tightly bound hemp plant filaments and fibers. The filaments and fibers are structured to a string like design similar to presently marketed silk, plastic, and bamboo floss; into a strong, string-like, durable structure. The hemp floss may be coated and flavored for friction and comfort. The coating may include dietary or medicinal properties and substances. In other embodiments, said hemp filament floss is not limited to morphing in regard to structure, components, coating, shape, size, texture, and style.

### CROSS-REFERENCE TO RELATED APPLICATIONS

Cross-reference Provisional Patent application: Hemp Filament Floss; No. 62/856,039; Filing date Jun. 1, 2019.

### FIELD OF INVENTION

The present invention relates to interdental aids used to debride bacteria and food debris from the interproximal surfaces of the teeth. To be more specific, this invention allows for an ecofriendly, non-plastic, hemp plant derived floss.

### BACKGROUND

In the Code of Federal Regulations, dental floss is discussed in Title 21 Food and Drug, Chapter-I Food and Drug Administration Department of Health and Human Services, Subchapter-H Medical Devices, Part-872 Dental Devices, Section-872.6390 Dental Floss. This section identifies dental floss is a string-like device made of cotton or other fibers intended to remove plaque and debris from between the teeth to reduce tooth decay. The U.S. Department of Health and Human Services reaffirmed flossing as “an important oral hygiene practice” in an August 2016 communication to the ADA.

Gingivitis and periodontal disease is a common diagnosis for millions of people. The Center for Disease Control 2012 stated that periodontal disease is a chronic inflammatory disease that affects the gum tissue and bone supporting the teeth, 1 out of every 2 American adults aged 30 and over has periodontal disease, and if not treated, periodontal disease can lead to tooth loss. It is also stated that periodontal disease is associated with other chronic inflammatory diseases, such as diabetes and cardiovascular disease. In order to effectively clean or debride ones mouth, a person must use not only a toothbrush, but an interdental as well. Interdental aids remove food debris and bacteria from the interproximal surfaces of the teeth.

There are many interdental aids on the market today that assist in maintaining a healthy periodontium. Interdental aids found on the market today are string floss, picks, pre-threaded flossers, brushes, powered air or water flossers, and wooden sticks.

Said devices work wonders if used with the proper technique. However, the majority of home-care interdental aids are one-time use plastic components, which are adding to the plastic pollution pandemic. Plastic floss, or synthetic floss (i.e. nylon, polyester, PTFE, UHMWPE,) is the most used and widely distributed. Plastic floss is known to cause death or harm in wildlife. In addition, discarded floss jams pumps in sewage treatment facilities. Plastic has also been known to disrupt human hormone levels and is made with crude oil, a non- renewable resource. Plastic floss can take up to 200 years to degrade and the container or base can take 500-1000 years. Hemp floss is a natural alternative; hemp degrades in 3-6 months. Silk is natural floss alternative, but can be expensive to produce and the production process involves boiling silk worms alive. Bamboo is another natural floss alternative, however it is not widely available and is not a natural fiber like hemp; bamboo is broken down into pulp, chemically processed and aged, then extrudes as a rayon fiber. Hemp is more sustainable than bamboo; it requires less water, is able to grow in contaminated soil without without any ill effect, and is kinder to the environment during the manufacturing process. Bamboo production also creates toxic chemicals, which is harmful to the workers processing it and does not maintain it's natural anti-bacterial properties after processing.

Due to industry and consumer demand, plastic pollution is at an all-time high. The world is producing more plastic than can be rid of, making for plastic gyres, marine life destruction, capped landfills, and a problem soon to be undeniable. Governments have started implementing one-time use plastic banns and laws, straws and plastic bags being the forerunners.

Seemingly old ways of thinking need to be re-imagined to protect life and resources. There is a need to replace one-time use interdental aid plastics with a more sustainable products.

### BRIEF SUMMARY OF THE INVENTIONS

The present invention comprises a novel floss consisting of hemp plant filament. The hemp plant is boiled in sodium hydroxide in a pressure cooker to remove lignin from the fibers in order to separate them from one another. The filament fibers are then gathered into a thread, and bleached with hydrogen peroxide to lighten the material and and remove any loose fibers. Next, the hemp is coated with wax and suitable flavors, additives, or medicinal products and can be used in one's mouth. This invention takes the place of the plastic floss, which is adding to the plastic pollution pandemic and natural alternatives; silk floss, which can become expensive to produce and relies upon the boiling of silk worms, and bamboo which is not a natural fiber and is toxic to produce. Hemp is natural, biodegrades quickly, and is much more environmentally friendly to produce.

### BRIEF DESCRIPTION OF THE DRAWINGS

Some embodiments of the present invention are illustrated as examples and are not limited by the figures or accompanied drawings in which like references may indicate similar elements and in which:

FIG. 1 depicts a front perspective view of one example of hemp filament floss.

FIG. 2 illustrates a front perspective view of one example of a wound hemp floss wheel.

### DETAILED DESCRIPTION OF THE INVENTION

The terminology used herein is for the purpose of describing particular embodiments only and is not intended to be limiting of the inventions. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which the inventions belong. It will be further understood that terms, such as those defined in commonly used dictionaries, should be interpreted as having as meaning that is consistent with their meaning in the context of the relevant art and the present disclosure and will not be interpreted in an idealized or overly formal sense unless expressly so defined herein.

In describing the inventions, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the inventions and the claims.

A novel interdental hemp plant filament floss and it's embodiments are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the inventions, and is not intended to limit the inventions to the specific embodiments illustrated by the figures or description below.

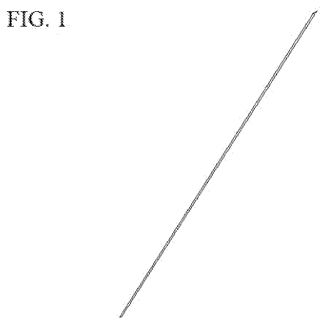

The present invention will now be described by referencing the appended figures representing preferred embodiments. FIG. 1 depicts a front perspective view of one example of hemp filament floss according to various embodiments of the present invention. In preferred embodiments, the hemp filament is tightly bound to form a tight string like material to mock the present marketed silk, bamboo, and plastic floss design. The wound filaments should be tightly bound and durable to withstand manual interdental debridement.

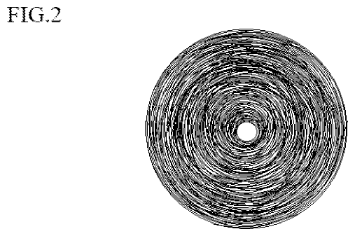

In preferred embodiments, the hemp filament floss is used to debride bacteria and food debris from the interproximal regions of the teeth. The floss may be slightly coated and flavored for friction, strength, and comfort. The floss may be also coated with CBD , THC, or any other suitable medicinal products. The floss may be wound in or onto wheels or spools and placed into an interdental aid devices or housing containers per FIG. 2 which illustrates a front perspective view of one example of a wound hemp floss wheel or used by itself.

While preferred materials for elements have been described, the floss is not limited by these materials. Said invention may be comprised by other elements in various embodiments of the present invention.

Although the present inventions have been illustrated and described herein with reference to preferred embodiments and specific examples thereof, it will be readily apparent to those of ordinary skill in the art that other embodiments and examples may perform similar functions and/or achieve like results. All such equivalent embodiments are examples are within the spirit and scope of the present invention, and are contemplated thereby, and are intended to be covered by the following claims.

what is claimed is:

1. A novel interdental hemp plant filament floss comprised of:
a. tightly bound hemp filaments and hemp fibers
b. a string-like, strong, durable structure
f. coated and flavored for friction and comfort
g. a coating may include dietary or medicinal properties and substances

2. The interdental hemp filament floss of claim 1 comprising of different thicknesses, structures, lengths, and coatings.
